(19) United States
(12) Patent Application Publication
(10) Pub. No.: US 2003/0009003 A1
(43) Pub. Date: Jan. 9, 2003

(54) Polyether carbonates

(76) Inventors: Burkhard Köhler, (US); Klaus Horn, Dormagen (DE); Rolf-Volker Meyer, Much (DE)

Correspondence Address: BAYER CORPORATION, PATENT DEPARTMENT, 100 BAYER ROAD, PITTSBURGH, PA, 15205, US

(21) Appl. No.: 10/149,947

(22) PCT Filed: Dec. 5, 2000
(86) PCT No.: PCT/EP00/12195

(30) Foreign Application Priority Data
Dec. 16, 1999 (DE) 19960776.1

(51) Int. Cl. C08G 64/00

(52) U.S. Cl. 528/196

(57) ABSTRACT

The invention relates to novel branched polyether carbonates, which are produced with the alpha-halocarboxylic esters of polyols as branching agent, whereby the branching agent is incorporated in the polycarbonate by means of ether bridges.

The present application relates to novel, branched polyether ester, especially polyether, carbonates, which have been produced with alpha-halogenated carboxylic acid esters of polyols as branching agents, the branching agent being incorporated in the polycarbonate via ether bridges.

Branched polycarbonates are known (US-RE-27682 or US-4 415 725). They are conventionally produced by the joint phosgenation of bisphenols in the presence of polyphenols. Owing to the pseudoplasticity of their melt, they are particularly well suited to blow-moulding processes, which are used e.g. for the production of bottles.

The branched polycarbonates produced in this way have too high a viscosity for some applications, however, and a relatively low toughness. Furthermore, polyphenols are often not readily accessible industrially and are available only in a limited selection (cf. EP-A-819 718).

The object is therefore to provide novel, branched polycarbonates with improved viscosity and toughness properties.

It has now been found that, in the phase boundary reaction of phosgene with diphenols and special branching agents, branched polycarbonates, in particular polyether carbonates, with a high notched impact strength and flow are obtained with conventional pseudoplasticity.

The invention thus provides branched polyether carbonates and polyether ester carbonates, containing alpha-halogenated carboxylic acid esters of polyols as branching agents, preferably with a functionality of 3-30.

The invention also provides a process for the production of especially branched polyether carbonates by reacting diphenols with phosgene and branching agents and optionally chain terminators by the two-phase boundary process, which is characterised in that alpha-halogenated carboxylic acid esters of polyols, preferably with a finctionality of 3-30, are used as branching agents, and the polycarbonates obtainable thereby.

The polycarbonates according to the invention preferably contain 0.05 to 3 mole % of the branching agents or these are preferably used in the process according to the invention.

The polycarbonates preferably contain 0.5 to 10 mole % chain terminators or these are preferably used in the process according to the invention.

The polyether carbonates according to the invention or obtainable by the process according to the invention have weight average Mw (determnined by gel chromatography by a known method) of 5,000-200,000, preferably of 10,000 to 50,000.

The compounds used as branching agents are known per se. Not yet known, and provided by the application, is the use of these special alpha-halogenated carboxylic acid esters of polyols, preferably with a functionality of 3 to 30, as branching agents in the production of polycarbonates.

Branching agents within the meaning of the invention to be used according to the invention are preferably the complete esterification products of:

polyols with at least 3 —OH groups such as, for example and preferably, pentaerythritol, trimethylolpropane, trimethylolethane, glycerol and the oligomerisation products of these polyols with degrees of oligomerisation of 2-10, sorbitol, mannitol or styrene-allyl alcohol copolymers with a molecular weight of 500 to 3000 and an allyl alcohol content of 10 to 50 wt. %, especially pentaerythritol, trimethylolpropane and trimethylolethane, with

1-halogenated carboxylic acids such as, for example and preferably, chloroacetic acid, bromoacetic acid, iodoacetic acid, 1-chloropropionic acid, 1-bromopropionic acid, 1-iodopropionic iodopropionic acid, 1-chloroisobutyric acid, 1-bromoisobutyric acid, 1-iodoisobutyric acid, 1-chlorophenylacetic acid, 1-bromophenylacetic acid, 1-iodophenylacetic acid, especially chloroacetic acid.

The alpha-halogenated carboxylic acid esters of polyols according to the invention are produced by generally known methods, preferably by esterification of the polyols with the alpha-halogenated carboxylic acids, preferably in the presence of an azeotropic entrainer, such as e.g. chlorobenzene, o-dichlorobenzene, xylene, mesitylene, toluene, chloroform, preferably in the presence of a catalyst, such as e.g. arylsulfonic acids, methanesulfonic acid, sulfuric acid, HCl, HBr, boric acid, phosphoric acid or tin or titanium compounds.

The alpha-halogenated carboxylic acid esters according to the invention can also be produced by reacting the acid chlorides of the alpha-halogenated carboxylic acids with the polyols in the presence of a base.

The alpha-halogenated carboxylic acid esters according to the invention can also be produced by a subsequent halogenation of carboxylic acid esters of the polyols.

Diphenols of formula (I)

HO-Z-OH (I)

with preferably 6 to 30 C atoms which are suitable for the production of the polycarbonates according to the invention are both mononuclear and polynuclear diphenols, which can contain heteroatoms and can have substituents which are inert under the conditions of the production and thermal treatment of the polycarbonate.

Hydroquinone, resorcinol, dihydroxydiphenyl, bis(hydroxyphenyl)alkanes, bis(hydroxyphenyl)cycloalkanes, bis(hydroxyphenyl) sulfides, ethers, ketones, sulfoxides, sulfones and α,α-bis(hydroxyphenyl)diisopropylbenzenes, and the ring-alkylated and ring-halogenated compounds thereof, can be mentioned as examples.

Suitable diphenols are described e.g. in U.S. Pat. Nos. 3,028,365, 2,999,835, 3,062,781, 3,148,172 and 4,982,014, in German published patent applications 1 570 703 and 2 063 050 and in the monograph “H. Schnell, Chemistry and Physics of Polycarbonates, Interscience Publishers, New York, 1964”.

Preferred diphenols are 4,4′-dihydroxydiphenyl, 2,2-bis(4-hydroxyphenyl)propane, 2,4-bis(4-hydroxyphenyl)-2-methylbutane, 1,1-bis(4-hydroxyphenyl)cyclohexane, α,α-bis(4-hydroxyphenyl)-p-diisopropylbenzene, 2,2-bis(3-methyl-4-hydroxyphenyl)propane, 2,2-bis(3-chloro-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl)sulfone, 2,4-bis(3,5-dimethyl-4-hydroxyphenyl)-2-methylbutane, 1,1-bis(3,5-dimethyl-4-hydroxyphenyl)cyclohexane, α,α′-bis(3,5-dimethyl-4-hydroxyphenyl)-p-diisopropylbenzene, 1,1-bis(4-hydroxyphenyl)-3,3,5-tri-methylcyclohexane, 1,1-bis(4-hydroxyphenyl)-3-methylcyclohexane, 1,1-bis(4-hydroxyphenyl)-3,3-dimethylcyclohexane, 1,1-bis(4-hydroxyphenyl)-4-methylcyclohexane, 2,2-bis(3,5-dichloro-4-hydroxyphenyl)propane and 2,2-bis(3,5-dibrome-4-hydroxyphenyl)propane.

Particularly preferred diphenols are e.g.:

2,2-bis(4-hydroxyphenyl)propane, 2,2-bis(3,5-dimethyl-4-hydroxyphenyl)propane, 2,2-bis(3,5-dichloro-4-hydroxyphenyl)propane, 2,2-bis(3,5-dibromo-4-hydroxyphenyl)propane, 1,1-bis(4-hydroxyphenyl)cyclohexane, 1,1-bis(4-hydroxy-phenyl)-3,3,5-trimethylcyclohexane, 1,1-bis(4-hydroxyphenyl)-3-methylcyclohexane, 1,1-bis(3,5-dimethyl-4-hydroxyphenyl)-4-methylcyclohexane.

2,2-Bis(4-hydroxyphenyl)propane and 1,1-bis(4-hydroxyphenyl)-3,3,5-trimethylcyclohexane are preferred in particular.

Any mixtures of the above-mentioned diphenols can also be used.

To improve the flow behaviour, in addition to the branching agents according to the invention, small quantities of conventional branching agents, preferably quantities of 0.05 to 2.0 mole % (based on moles of diphenols used) of preferably tri- or more than trifunctional compounds, especially those with three or more than three phenolic hydroxyl groups, can be jointly used in a known manner. Some of the compounds with three or more than three phenolic hydroxyl groups that can be used are, for example, 1,3,5-tri(4-hydroxyphenyl)benzene, 1,1,1-tri(4-hydroxyphenyl)ethane, 2,6-bis(2-hydroxy-5′-methylbenzyl)-4-methylphenol, 2-(4-hydroxyphenyl)-2-(2,4-dihydroxyphenyl)propane, hexa(4-(4-hydroxyphenylisopropyl)phenyl)ortho-terephthalate, tetra(4-hydroxyphenyl)methane and 1,4-bis(4′,4″-dihydroxytriphenyl)-methyl)benzene. Some of the other trifunctional compounds are 2,4-dihydroxybenzoic acid, trimesic acid, cyanuric chloride and 3,3-bis(4-hydroxy-3-methylphenyl)-2-oxo-2,3-dihydroindole.

The production according to the invention of the branched polyether carbonates is, preferably and by way of an example, carried out as follows:

The diphenols to be used are dissolved in an aqueous alkaline phase and this is taken as the starting solution. The quantities of chain terminators needed for the production (0.5 to 10 mole %) and of alpha-halogenated carboxylic acid esters of polyols (0.05 to 3 mole %) used as branching agents are added to this, dissolved in an organic solvent or in substance. The reaction with phosgene is then performed in an inert organic phase, preferably dissolving polycarbonate, for example and preferably dichloromethane, the various dichloroethanes and chloropropane compounds, chlorobenzene and chlorotoluene, especially dichloromethane and mixtures of dichloromethane and chlorobenzene. The reaction temperature is generally 0° C. to 40° C.

Suitable chain terminators are e.g. phenol or p-tert.-butylphenol, but also long-chain alkylphenols such as 4-(1,3-tetramethylbutyl)phenol according to DE-A 2 842 005 or monoalkylphenols or dialkylphenols with a total of 8 to 20 C atoms in the alkyl substituents according to German patent application DE-A 3 506 472, such as e.g. p-nonylphenol, 2,5-di-tert.-butylphenol, p-tert.-octylphenol, p-dodecylphenol, 2-(3,5-dimethylheptyl)phenol and 4-(2,5-dimethylheptyl)phenol. The quantity of chain terminators to be used is generally between 0.5 and 10 mole %, based on the sum of the diphenols (I.) used in each case.

The addition of the necessary chain terminators and branching agents can also take place during the phosgenation.

Suitable organic solvents for the chain terminators and branching agents are, for example and preferably, methylene chloride, chlorobenzene, mixtures of methylene chloride and chlorobenzene, acetone, acetonitrile, toluene.

The incorporation of the branching agents used according to the invention in the polymer chain takes place via an aryloxy carboxylic acid ester group, the halogen being displaced by the phenolate in a nucleophilic substitution with the formation of an ether group. Chloroacetates of polyols are preferred, as in this case only chloride ions (from phosgene and branching agents) are formed during the polymer synthesis.

The additives that are conventional for thermoplastic polycarbonates, such as stabilisers, mould release agents, pigments, flame retardants, antistatic agents, fillers and reinforcing materials, can be added to the branched polyether carbonates according to the invention in the conventional quantities before or after these are processed.

The process according to the invention for the production of the branched polyether carbonates can also be extended to branched polyether ester carbonates by replacing some of the carbonate donors by reactive dicarboxylic acid derivatives, preferably by aromatic dicarboxylic acid chlorides. The polyether ester carbonates, the production and use thereof and the objects produced therefrom are also provided by the present application.

Like branched polycarbonates, the branched polyether carbonates according to the invention display pseudoplasticity, as a result of which they are particularly well suited for processing into hollow articles by the blow-moulding process.

The branched polyether carbonates according to the invention are distinguished by particularly good toughness and flow.

The polycarbonates according to the invention are used as thermoplastic moulding compositions for the production of mouldings, especially for the production of hollow articles by the blow-moulding process. The present application thus also provides this use and the mouldings or hollow articles produced from the polycarbonate moulding compositions according to the invention.

The mouldings or hollow articles are produced by methods which are known per se, for example by extrusion or injection moulding, in particular . . .

The mouldings or hollow articles according to the invention, such as e.g. bottles, housings for electrical appliances, domestic appliances, toys or mouldings for use in car construction, for optical instruments and in the electrical sector, are distinguished by improved toughness and impact strength.

The following examples serve to explain the invention. The invention is not restricted to the examples.

### EXAMPLES

### Example 1

100 g pentaerythritol, 400 g chloroacetic acid, 300 ml o-dichlorobenzene and 2 g p-toluenesulfonic acid are mixed and heated to 160° C. until no more water distils off. The organic phase is washed three times with water and once with 5% sodium hydroxide solution, during which the product precipitates. Suction is applied, followed by washing with petroleum ether and drying in vacuo. 251 g of pentaerythritol tetrachloroacetate are obtained (evidence of structure by 1H-NMR).

### Example 2

100 g trimethylolpropane, 400 g bromoacetic acid, 400 ml o-dichlorobenzene and 2 g p-toluenesulfonic acid are mixed and heated to 160° C. until no more water distils off. The organic phase is washed once with water, twice with 5% sodium hydroxide solution and twice with water. All components volatile up to 120° C. are distilled off in vacuo (1 torr). 281 g of trimethylolpropane tribromoacetate are obtained (evidence of structure by 1H-NMR).

### Example 3

7822 g 45% sodium hydroxide solution, 40 kg water, 4566 g bisphenol A, 10 l chiorobenzene, 30 l methylene chloride, 25.4 g trimethylolpropane tribromoacetate (0.5 wt. %) as branching agent, 105 g p-tert.-butylphenol (3.5 mole %) and 28 ml N-ethylpiperidine are taken as the starting mixture, 3200 g phosgene are introduced at 20° C. and stirring is continued for 1 h. Acidification is performed with HCl and the organic phase is separated off and evaporated on an evaporating extruder (280° C., vacuum). 4350 g of branched polyether carbonate according to the invention are obtained.

### Example 4

The procedure described in example 3 is followed, using 25.4 g pentaerythritol tetrachloroacetate as branching agent. 4350 g of branched polyether carbonate according to the invention are obtained.

### Comparative Example 1

The procedure described in example 3 is followed, using 25.4 g 1,1,1-trihydroxyphenylethane as branching agent. 4340 g of branched polyether carbonate are obtained.

| | Viscosity | Viscosity | | |
|---|---|---|---|---|
| | 300° C. | 300° C. | | Notched impact |
| | shear | shear | | strength ak |
| | eta 10 | eta 1000 | Eta 10: | at 0° C. |
| | (Pa s) | (Pa s) | eta 1000 | (kJ/m²) |
| Example 3 | 672 | 352 | 1.9 | 93 |
| Example 4 | 792 | 420 | 1.9 | 93 |
| Comparison 1 | 1103 | 584 | 1.9 | 78 |

The branched polyether carbonates according to the invention have the same pseudoplasticity (quotient of the viscosity at eta 10/eta 1000 as the quantity), but are distinguished by better flow and better notched impact strength.

1. Branched polyether carbonates and polyether ester carbonates containing alpha-halogenated carboxylic acid esters of polyols as branching agents.

2. Polyether carbonates and polyether ester carbonates according to claim 1, containing pentaerythritol tetrachloroacetate and/or trimethylolpropane trichloroacetate and/or trimethylolethane trichloroacetate as branching agents.

3. Process for the production of branched polyether carbonates by the reaction of diphenols with phosgene and branching agents and optionally chain terminators by the two-phase boundary process, which is characterised in that alpha-halogenated carboxylic acid esters of polyols are used as branching agents.

4. Polyether carbonates obtainable by the process as defined in claim 3.

5. Process for the production of branched polyether ester carbonates by the reaction of diphenols with phosgene and branching agents and optionally chain terminators by the two-phase boundary process, which is characterised in that alpha-halogenated carboxylic acid esters of polyols are used as branching agents and some of the carbonate donors are replaced by reactive dicarboxylic acid derivatives.

6. Polyether ester carbonates obtainable by the process as defined in claim 5.

7. Process according to at least one of claims 2 and 5, wherein 0.5 to 10 mole % chain terminators and 0.05 to 3 mole % branching agents are used.

8. Use of alpha-halogenated carboxylic acid esters of polyols as branching agents for the production of polyether carbonates or polyether ester carbonates.

9. Use of the polyether carbonates and polyether ester carbonates for the production of mouldings and hollow articles.

10. Mouldings produced from polyether carbonates and/or polyether ester carbonates as defined in any of the above claims.

11. Moulding compositions containing polyether carbonates and/or polyether ester carbonates as defined in any of the above claims.

12. Mouldings and hollow articles containing polyether carbonates and/or polyether ester carbonates as defined in any of the above claims.

13. Use of the polymer compounds according to claim 1 for the production of hollow articles by the blow-moulding process.
